(19) United States
(12) Patent Application Publication
(10) Pub. No.: US 2017/0031557 A1
(43) Pub. Date: Feb. 2, 2017

(54) METHOD AND APPARATUS FOR ADJUSTING SHOOTING FUNCTION

(71) Applicant: Xiaomi Inc., Beijing (CN)

(72) Inventors: Fei XIANGLI, Beijing (CN); Zhuang QIAN, Beijing (CN); Baoke CHEN, Beijing (CN)

(21) Appl. No.: 15/156,343

(22) Filed: May 17, 2016

(30) Foreign Application Priority Data
Jul. 31, 2015 (CN) 201510462838.7

(51) Int. Cl. G06F 3/0488; H04N 5/232; G06F 3/041

(52) U.S. Cl. CPC G06F 3/0488; G06F 3/0416; H04N 5/23216

(57) ABSTRACT

A method for adjusting a shooting function including: upon detecting an initialization of a function of a shooting application, monitoring, under the operating interface of the shooting application, whether a preset touch control operation is received on a preset touch control region on the display screen. The touch control region is preset according to a strategy for ease of a single hand operation. The method further includes: if it is determined that the touch control operation is received in the touch control region, switching operation status of an element associated with the shooting application according to preset control information.

### CROSS-REFERENCE TO RELATED APPLICATIONS

This application is based upon and claims priority to Chinese Patent Application 201510462838.7, filed on Jul. 31, 2015, the entire contents of which is incorporated herein by reference.

### TECHNICAL FIELD

The present disclosure relates to a technical field of signal control, and more particularly, to a control method and an apparatus for adjusting a shooting function.

### BACKGROUND

With the popularity of smart phones, a built-in shooting function has been widely accepted and becomes one of the most important functions of smart phones. During shooting, a user often encounters such a situation where it is necessary to manually switch a front camera or a rear camera for different shooting purposes.

### SUMMARY

According to a first aspect of the embodiments of the present disclosure, there is provided a method for adjusting a shooting function. The method includes: upon detecting an initialization of a function of a shooting application, monitoring, under the operating interface of the shooting application, whether a preset touch control operation is received on a preset touch control region on the display screen. The touch control region is preset according to a strategy for ease of a single hand operation. The method further includes: if it is determined that the touch control operation is received in the touch control region, switching operation status of an element associated with the shooting application according to preset control information.

According to a second aspect of the embodiments of the present disclosure, there is provided a terminal apparatus with a shooting function. The terminal apparatus includes: a processor; an element associated with the shooting application; and a memory for storing instructions executable by the processor. The processor is configured to perform: upon detecting an initialization of a function of a shooting application, monitoring, under the operating interface of the shooting application, whether a preset touch control operation is received on a preset touch control region on the display screen. The touch control region is preset according to a strategy for ease of a single hand operation. The processor is configured to perform: if it is determined that the touch control operation is received in the touch control region, switching operation status of the element associated with the shooting application according to preset control information.

According to a third aspect of the the embodiments of the present disclosure, there is provided a non-transitory computer-readable storage medium having stored therein instructions that, when executed by a processor of terminal apparatus, causes the terminal apparatus to perform a method for adjusting a shooting function. The method includes: upon detecting an initialization of a function of a shooting application, monitoring, under the operating interface of the shooting application, whether a preset touch control operation is received on a preset touch control region on the display screen. The touch control region is preset according to a strategy for ease of a single hand operation. The method further includes: if it is determined that the touch control operation is received in the touch control region, switching operation status of an element associated with the shooting application according to preset control information.

It is to be understood that both the foregoing general description and the following detailed description are exemplary and explanatory only and are not restrictive of the present disclosure.

### BRIEF DESCRIPTION OF THE DRAWINGS

The accompanying drawings herein, which are incorporated in and constitute a part of this specification, illustrate embodiments consistent with the present disclosure. These accompanying drawings, together with the specification, serve to explain the principles of the present disclosure.

FIG. 1 is a flow chart illustrating a control method for adjusting a shooting function, according to an exemplary embodiment;

FIG. 2 is a flow chart illustrating a control method for adjusting a shooting function, according to another exemplary embodiment;

FIG. 3 is a schematic diagram illustrating a touch control region on the display screen of a terminal apparatus;

FIG. 4 is a flow chart illustrating a control method for adjusting a shooting function, according to another exemplary embodiment;

FIG. 5 is a schematic diagram illustrating a plurality of touch control regions on the display screen of a terminal apparatus;

FIG. 6 is a block diagram illustrating a control device for adjusting a shooting function, according to an exemplary embodiment;

FIG. 7 is a block diagram illustrating a control device for adjusting a shooting function, according to another exemplary embodiment;

FIG. 8 is a block diagram illustrating a control device for adjusting a shooting function, according to another exemplary embodiment;

FIG. 9 is a block diagram illustrating a terminal apparatus with a shooting function, according to an exemplary embodiment; and

FIG. 10 is a block diagram illustrating a terminal apparatus with a shooting function, according to an exemplary embodiment.

Particular embodiments of the present disclosure have been illustrated in the above drawings and will be described in further detail hereinafter. The drawings and written descriptions are not intended to limit the scope of the disclosed concept in any way, rather, they are provided to explain the concept of the present disclosure to those skilled in the art by referring to particular embodiments.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of apparatuses and methods consistent with aspects related to the present disclosure as recited in the appended claims.

FIG. 1 is a flow chart illustrating a control method for adjusting a shooting function, according to an exemplary embodiment. The method may include the following steps:

In step 101, upon detecting an initialization of a function of a shooting application, monitoring is initialized under the operating interface of the shooting application. The monitoring is to determine whether a preset touch control region on the display screen receives a preset touch control operation; the touch control region is preset according to a strategy for ease of a single hand operation.

In the present embodiment, the implementation process of the control method for adjusting the shooting function should be described under a control device for adjusting a shooting function, and the control device should be positioned in a terminal apparatus with a shooting function. For example, the terminal apparatus with a shooting function includes: a cell phone and a personal portable computer with cameras, a camera or a video camera.

A touch control region for switching operation status of an element associated with the shooting application is preset on the display screen of the terminal apparatus with a shooting function. The touch control region is positioned at such a location on the display screen of the terminal apparatus to facilitate the user to make a touch control operation during a single hand holding shooting. For example, the touch control region may be a right side region along the vertical direction of the display screen, or the touch control region may be a left side region along the vertical direction of the display screen, or the touch control region may be a lower side region along the horizontal direction of the display screen. The particular position of the touch control region may be determined according to actual requirements of the application, which is not limited to the present embodiment.

The control device for adjusting a shooting function monitors the preset touch control region and determines whether a touch control operation is received; the detailed operation principle is that: if the display screen of the terminal apparatus is a touch control screen based on capacitive sensing, a capacitor, generally having an induced capacitance of several pF to several tens of pF, may be formed between the touch control screen and the ground when the user's finger touches the touch control screen, with the user equivalent to a capacitor connected to the ground. Accordingly, it may be detected whether the user touches the touch control screen based on the variation of the capacitance and an internal timer. When it is determined that the sensing button on the capacitive sensor is pressed, a touch control operation is transmitted with an identifier of a general input/output interface GPIO; basing on the identifier of the GPIO, a preset location information table may be looked up to obtain a location information of the touch control region corresponding to the identifier of the GPIO. Accordingly, it can be determined whether the user is performing a touch control operation on the touch control region.

Specifically, after the control device for adjusting a shooting function determining a touch control operation is received in the touch control region, the operation principle of determining whether a touch control operation is the preset touch control operation is that: acquiring a changing trend according to the touch control operation received during a preset time; calculating a precise current location of the center of the finger using a interpolation algorithm; converting the change of the location, i.e. a slide direction and distance of the finger, into input information of the user; and acquiring the touch control operation of the user in the touch control region. In one embodiment, the touch control operation includes: single finger tapping, multi-finger tapping, double click, single finger sliding, and/or multi-finger sliding.

In step 102, if it is determined that the touch control operation is received on the touch control region, operation status of an element associated with the shooting application is switched according to preset control information.

If it is determined that the touch control operation is received on the touch control region, the control device for adjusting a shooting function switches the operation status of an element associated with the shooting application according to preset control information.

Those skilled in the art should appreciate that the element associated with the shooting application includes a flashing light, a camera, and the like. For example, if the element is a flashing light, the operation status corresponding to the flashing light includes ON, OFF, AUTO, and the like. If the element is a camera, the operation status corresponding to the camera includes a front camera shooting status and a rear camera shooting status. If the element is a front camera, the operation status corresponding to the front camera includes a photo shooting status or a video shooting status. If the element is a rear camera, the operation status corresponding to the rear camera includes a photo shooting status or a video shooting status.

An example is as follow.

During a shooting in which a current operation status of the camera is a rear camera shooting status, if a self-shooting is required, the user applies a touch control operation on a preset touch control region easy for operation, and the operation status of the camera is switched from the rear camera shooting status to the front camera shooting status according to the touch control operation.

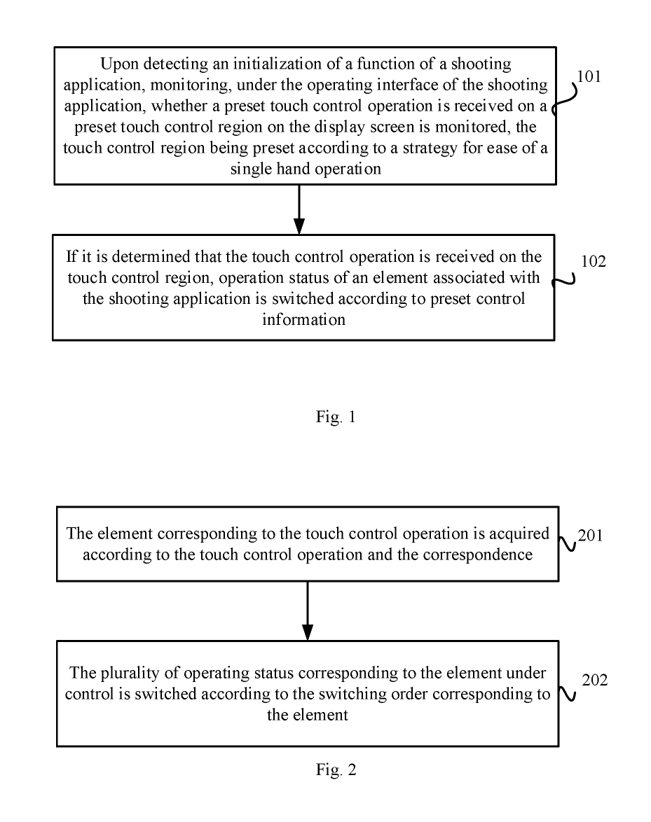

In conclusion, in the control method for adjusting a shooting function, a touch control region is preset on the display screen with a shooting function and it monitors whether a preset control operation is received on the preset touch control region on the display screen. If it is determined that the touch control operation is received on the touch control region, then operation status of the element associated with the shooting application is switched according to the preset control information. Accordingly, with the manipulation of the user to the easily touchable touch control region during shooting, the operation status of the element can be conveniently switched, which improves shooting efficiency and quality. One or more touch control regions may be provided in the embodiment illustrated in FIG. 1. Different arrangements of the touch control region may correspond to different control information, and the analyzing processes of the acquired touch control operation of the control device for adjusting a shooting function may be different. In order to further describe the process of switching among a plurality of operation status of the element according to the preset control information, a detailed description is provided with reference to FIGS. 2-5 as follows.

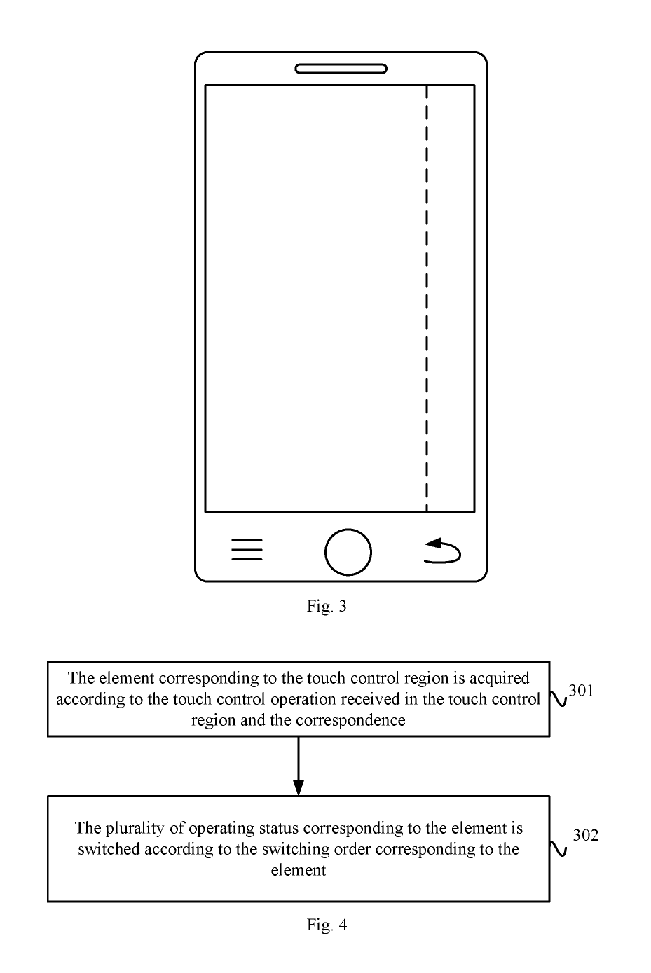

FIG. 2 is a flow chart illustrating a control method for adjusting a shooting function, according to another exemplary embodiment. The present embodiment corresponds to a scenario of comprising one touch control region. One example is FIG. 3, which is a schematic diagram illustrating a touch control region on the display screen of the terminal apparatus.

According to the present embodiment, the touch control information includes: a correspondence between the touch control operation and the element, and a switching order corresponding to the plurality of operation status of the element. Therefore, with respect to the step 102 of the embodiment illustrated in FIG. 1, after determining that the touch control operation is received in the touch control region, the detailed process for switching the operation status of the element associated with the shooting application according to the preset control information may include steps as follows:

In step 201, an element corresponding to the touch control operation is acquired according to the correspondence and the touch control operation.

A preset correspondence in the control information is inquired to obtain the element corresponding to the touch control operation. For example, a double click corresponds to the camera, and a single finger sliding corresponds to the flashing light.

In step 202, a plurality of operation status corresponding to the element currently under control is switched according to a switching order corresponding to the element.

A preset switching order in the control information is inquired to obtain the switching order corresponding to the current element, and the plurality of operation status corresponding to the element is switched accordingly.

In order to describe the above implementation in further detail, an example is as follows.

In the present embodiment, the control information includes: a double click touch control operation corresponds to the camera, and a single finger sliding touch control operation corresponds to the flashing light; the switching order corresponding to the camera is “a front camera shooting status—a rear camera shooting status”, and the switching order corresponding to the flashing light is “ON—OFF—AUTO”.

Upon detection of the touch control operation of the user on the touch control region, if it is determined that the touch control operation is a double click, the camera is determined as the element currently under control; and if the current operation status of the camera is a front camera shooting status, it is switched to a rear camera shooting status according to the switching order “a front camera shooting status—a rear camera shooting status” corresponding to the camera.

In conclusion, in the control method for adjusting a shooting function provided in the present embodiment, when the preset touch control operation is detected in a preset touch control region, the plurality of operation status corresponding to the element is switched according to the correspondence between the touch control operation and the element, and according to the switching order corresponding to the element associated with the control information. Accordingly, with the manipulation of the user to the easily touchable touch control region during shooting, the operation status of the element can be conveniently switched, which improves shooting efficiency and quality. Furthermore, the user experience would be improved by providing a customized service according to the touch control habits of the user.

FIG. 4 is a flow chart illustrating a control method for adjusting a shooting function, according to another exemplary embodiment. The present embodiment corresponds to a scenario of comprising a plurality of touch control regions. One example is FIG. 5, which is a schematic diagram illustrating a plurality of touch control regions on the display screen of a terminal apparatus.

According to the present embodiment, the touch control information includes: a correspondence between the touch control operation in each control region and the element, and a switching order corresponding to the plurality of operation status of the element. Therefore, with respect to the step 102 of the embodiment illustrated in FIG. 1, after determining that the touch control operation is received in the touch control region, the detailed process for switching the operation status of the element associated with the shooting application according to the preset control information may include steps as follows:

In step 301, an element corresponding to the touch control region is acquired according to the correspondence and the touch control region receiving the touch control operation.

Specifically, the control device for adjusting a shooting function detecting the touch control region corresponding to the touch control; the detailed operation principle is that: when the display screen of the terminal apparatus is, for example, a touch control screen based on capacitive sensing, a capacitor, generally having an induced capacitance of several pF to several tens of pF, may be formed between the touch control screen and the ground when the user's finger touches the touch control screen as the user may correspond to a capacitor connected to the ground. Accordingly, it may be detected whether the user touches the touch control screen based on the variation of the capacitance and an internal timer. When it is determined that the sensing button on the capacitive sensor is pressed, a transmitted touch control operation includes an identifier of a general input/output interface GPIO; basing on the identifier of the GPIO, a preset location information table may be looked up to obtain a location information of the touch control region corresponding to the identifier of the GPIO. Accordingly, the touch control region corresponding to the touch control operation may be determined.

The element corresponding to the touch control region may be obtained according to the touch control region receiving the touch control operation, and based on the correspondence between the touch control operation in each touch control region and the element preset in the control information.

In step 302, a plurality of operation status corresponding to the element currently under control is switched according to a switching order corresponding to the element.

A switching order corresponding to the current element is inquired, and the plurality of operation status corresponding to the element is switched according to the switching order corresponding to the element associated with the control information.

In order to describe the above implementation in further detail, an example is as follows:

In the present embodiment, the touch control region includes a left side region and a right side region.

The preset control information includes: a double click touch control operation on the left side region corresponds to the camera, and the switching order corresponding to the camera is “a front camera shooting status—a rear camera shooting status”; and a single finger sliding touch control operation on the right side region corresponds to the flashing light, and the switching order corresponding to the flashing light is “ON—OFF—AUTO”.

Upon detection of a double click touch control operation on the left side region of the user, the camera is determined as the element currently under control; and if the current operation status of the camera is a front camera shooting status, it is switched to a rear camera shooting status according to the switching order “a front camera shooting status—a rear camera shooting status” corresponding to the camera.

In conclusion, in the control method for adjusting a shooting function provided in the present application, when the preset touch control operation is detected in the preset plurality of touch control regions, the plurality of operation status corresponding to the element is switched according to the correspondence between the touch control operation in each touch control region and the element, and according to the switching order corresponding to the element associated with the control information. Accordingly, with the manipulation of the user to the easily touchable touch control region during shooting, the operation status of the element can be conveniently switched, which improves shooting efficiency and quality. Furthermore, the user experience would be improved by providing a customized service according to the touch control habits of the user.

The followings are device embodiments of the present disclosure, which may be configured to perform the method embodiments of the present disclosure. With respect to the details that are not described in the device embodiments, please refer to the embodiments regarding the methods of the present disclosure.

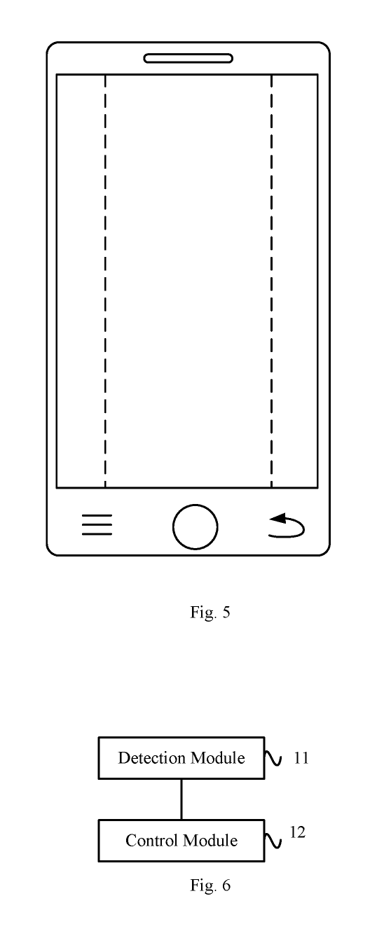

FIG. 6 is a block diagram illustrating a control device for adjusting a shooting function according to an exemplary embodiment. The control device for adjusting a shooting function may be implemented by software, hardware or a combination of the both. The control device for adjusting a shooting function may include the components as follows:

A detecting module 11 is configured to, upon detecting an initialization of a function of a shooting application, initialize a monitoring of whether a preset touch control operation is received on a preset touch control region of the operating interface of the shooting application on the display screen, the preset touch control region being preset according to a strategy for ease of a single hand operation.

A control module 12 is configured to switch operation status of an element associated with the shooting application according to the preset control information, if it is determined that the touch control operation is received in the touch control region.

In conclusion, in the control method for adjusting a shooting function, a touch control region is preset on the display screen with a shooting function and it monitors whether a preset control operation is received on the preset touch control region on the display screen. If it is determined that the touch control operation is received on the touch control region, then operation status of the element associated with the shooting application is switched according to the preset control information. Accordingly, with the manipulation of the user to the easily touchable touch control region during shooting, the operation status of the element can be conveniently switched, which improves shooting efficiency and quality. In the control device for adjusting a shooting function provided according to an exemplary embodiment, the touch control operation includes, but not limited to, single finger tapping, multi-finger tapping, double click, single finger sliding, and/or multi-finger sliding.

The touch control region includes, but not limited to, a left side region of the display screen, a right side region of the display screen, and/or a lower side region of the display screen.

If the element is a camera, the control module is configured to perform: switching the operation status of the camera into a front camera shooting status or a rear camera shooting status according to the preset control information.

If the element is a flashing light, the control module is configured to perform: switching the operation status of the flashing light into ON, OFF, or AUTO according to the preset control information.

If the element is a front camera, the control module is configured to perform: switching the operation status of the front camera into a photo shooting status or a video shooting status according to the preset control information.

If the element is a rear camera, the control module is configured to perform: switching the operation status of the rear camera into a photo shooting status or a video shooting status according to the preset control information.

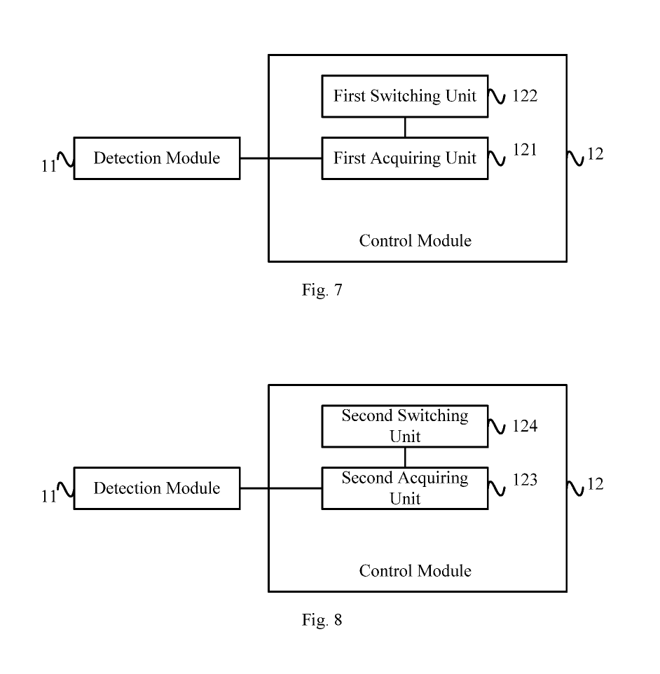

FIG. 7 is a block diagram illustrating a control device for adjusting a shooting function illustrated according to an exemplary embodiment. The control device for adjusting a shooting function may be implemented by software, hardware or a combination of the both. Basing on the embodiment in FIG. 6 and as illustrated in FIG. 7,

If the touch control region includes one region, the control information includes: a correspondence between the touch control operation and the element, and a switching order corresponding to a plurality of operation status of the element. Moreover, the control module 12 includes: a first acquiring unit 121, configured to acquire the element corresponding to the touch control operation according to the touch control operation and the correspondence; and a first switching unit 122, configured to switch among the plurality of operation status corresponding to the element under control according to the switching order corresponding to the element.

In conclusion, in the control method for adjusting a shooting function provided in the present application, when the preset touch control operation is detected in a preset touch control region, the plurality of operation status corresponding to the element is switched according to the correspondence between the touch control operation and the element, and according to the switching order corresponding to the element associated with the control information. Accordingly, with the manipulation of the user to the easily touchable touch control region during shooting, the operation status of the element can be conveniently switched, which improves shooting efficiency and quality. Furthermore, the user experience would be improved by providing a customized service according to the touch control habits of the user. FIG. 8 is a block diagram illustrating a control device for adjusting a shooting function according to an exemplary embodiment. The control device for adjusting a shooting function may be implemented by software, hardware or a combination of the both. Basing on the embodiment in FIG. 6 and as illustrated in FIG. 8.

If the touch control region includes a plurality of touch control regions, the control information includes: a correspondence between the touch control operation in each touch control region and the element, and a switching order corresponding to a plurality of operation status of the element. Moreover, the control module 12 includes: a second acquiring unit 123, configured to acquire the element corresponding to the touch control region according to the touch control operation received in the touch control region and the correspondence; and a second switching unit 124, configured to switch among the plurality of operation status corresponding to the element according to the switching order corresponding to the element.

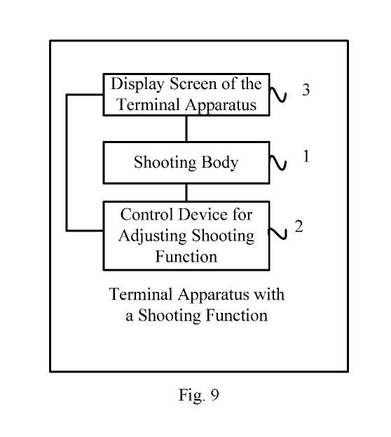

In conclusion, in the control method for adjusting a shooting function provided in the present application, when the preset touch control operation is detected in a preset touch control region, the plurality of operation status corresponding to the element is switched according to the correspondence between the touch control operation and the element, and according to the switching order corresponding to the element associated with the control information. Accordingly, with the manipulation of the user to the easily touchable touch control region during shooting, the operation status of the element can be conveniently switched, which improves shooting efficiency and quality. Furthermore, the user experience would be improved by providing a customized service according to the touch control habits of the user. FIG. 9 is a block diagram illustrating a terminal apparatus with a shooting function according to an exemplary embodiment. As illustrated in FIG. 9, the apparatus includes: a shooting body 1, a control device 2 for adjusting a shooting function provided in the above embodiments of the present disclosure, and a display screen 3 of the terminal apparatus.

In one embodiment, the terminal apparatus includes a cellphone, a camera, a video camera and a personal palm computer.

In one embodiment, the shooting body 1 includes a flashing light and/or a camera, etc.

In conclusion, in the control method for adjusting a shooting function, a touch control region is preset on the display screen with a shooting function, it monitors whether a preset control operation is received on the preset touch control region on the display screen. If it is determined that the touch control operation is received on the touch control region, then operation status of the element associated with the shooting application is switched according to the preset control information. Accordingly, with the manipulation of the user to the easily touchable touch control region during shooting, the operation status of the element can be conveniently switched, which improves shooting efficiency and quality.

An embodiment of the present disclosure provides a terminal apparatus with a shooting function, which may perform the above described method for adjusting a shooting function provided in the present disclosure.

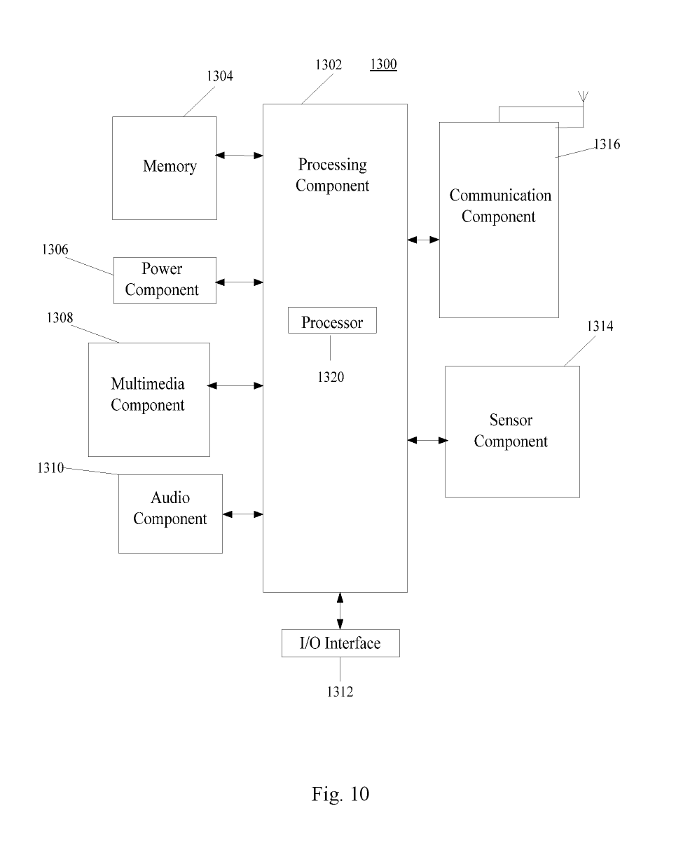

FIG. 10 is a block diagram of a terminal apparatus 1300 with a shooting function according to an exemplary embodiment. For example, the apparatus 1300 may be a mobile phone, a computer, a digital broadcast terminal, a messaging device, a gaming console, a tablet, a medical device, exercise equipment, a personal digital assistant, and the like.

Referring to FIG. 10, the apparatus 1300 may include one or more of the following components: a processing component 1302, a memory 1304, a power component 1306, a multimedia component 1308, an audio component 1310, an input/output (I/O) interface 1312, a sensor component 1314, and a communication component 1316.

The processing component 1302 typically controls overall operations of the apparatus 1300, such as the operations associated with display, telephone calls, data communications, camera operations, and recording operations. The processing component 1302 may include one or more processors 1320 to execute instructions to perform all or part of the steps in the above described methods. Moreover, the processing component 1302 may include one or more modules which facilitate the interaction between the processing component 1302 and other components. For instance, the processing component 1302 may include a multimedia module to facilitate the interaction between the multimedia component 1308 and the processing component 1302.

The memory 1304 is configured to store various types of data to support the operation of the apparatus 1300. Examples of such data include instructions for any applications or methods operated on the apparatus 1300, contact data, phonebook data, messages, pictures, video, etc. The memory 1304 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1306 provides power to various components of the apparatus 1300. The power component 1306 may include a power management system, one or more power sources, and any other components associated with the generation, management, and distribution of power in the apparatus 1300.

The multimedia component 1308 includes a screen providing an output interface between the apparatus 1300 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 1308 includes a front camera and/or a rear camera. The front camera and the rear camera may receive an external multimedia datum while the apparatus 1300 is in an operation mode, such as a photographing mode or a video mode. Each of the front camera and the rear camera may be a fixed optical lens system or have focus and optical zoom capability.

The audio component 1310 is configured to output and/or input audio signals. For example, the audio component 1310 includes a microphone (“MIC”) configured to receive an external audio signal when the apparatus 1300 is in an operation mode, such as a call mode, a recording mode, and a voice recognition mode. The received audio signal may be further stored in the memory 1304 or transmitted via the communication component 1316. In some embodiments, the audio component 1310 further includes a speaker to output audio signals.

The I/O interface 1312 provides an interface between the processing component 1302 and peripheral interface modules, such as a keyboard, a click wheel, buttons, and the like. The buttons may include, but are not limited to, a home button, a volume button, a starting button, and a locking button.

The sensor component 1314 includes one or more sensors to provide status assessments of various aspects of the apparatus 1300. For instance, the sensor component 1314 may detect an open/closed status of the apparatus 1300, relative positioning of components, e.g., the display and the keypad, of the apparatus 1300, a change in position of the apparatus 1300 or a component of the apparatus 1300, a presence or absence of user contact with the apparatus 1300, an orientation or an acceleration/deceleration of the apparatus 1300, and a change in temperature of the apparatus 1300. The sensor component 1314 may include a proximity sensor configured to detect the presence of nearby objects without any physical contact. The sensor component 1314 may also include a light sensor, such as a CMOS or CCD image sensor, for use in imaging applications. In some embodiments, the sensor component 1314 may also include an accelerometer sensor, a gyroscope sensor, a magnetic sensor, a pressure sensor, or a temperature sensor.

The communication component 1316 is configured to facilitate communication, wired or wirelessly, between the apparatus 1300 and other devices. The apparatus 1300 can access a wireless network based on a communication standard, such as WiFi, 2G or 3G or a combination thereof. In one exemplary embodiment, the communication component 1316 receives a broadcast signal or broadcast associated information from an external broadcast management system via a broadcast channel. In one exemplary embodiment, the communication component 1316 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the apparatus 1300 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 1304, executable by the processor 1320 in the apparatus 1300, for performing the above-described methods. For example, the non-transitory computer-readable storage medium may be a ROM, a RAM, a CD-ROM, a magnetic tape, a floppy disc, an optical data storage device, and the like.

A non-transitory computer-readable storage medium, when instructions in the storage medium is executed by the processor of the apparatus 1300, enables the apparatus 1300 to perform a control method described above.

Other embodiments of the present disclosure will be apparent to those skilled in the art from consideration of the specification and practice of the present disclosure disclosed here. This application is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the present disclosure being indicated by the following claims.

It will be appreciated that the present disclosure is not limited to the exact construction that has been described above and illustrated in the accompanying drawings, and that various modifications and changes can be made without departing from the scope thereof It is intended that the scope of the present disclosure only be limited by the appended claims.

What is claimed is:

1. A control method for adjusting a shooting function, comprising:
upon detecting an initialization of a function of the shooting application, monitoring, under the operating interface of the shooting application, whether a preset touch control operation is received on a preset touch control region on the display screen, the touch control region being preset according to a strategy for ease of a single hand operation; and
if it is determined that the touch control operation is received on the touch control region, switching operation status of an element associated with the shooting application according to preset control information.

2. The method according to claim 1, wherein if the element associated with the shooting application is a camera, switching the operation status of the element associated with the shooting application according to the preset control information comprises:
switching the operation status of the camera into a front camera shooting status or a rear camera shooting status according to the preset control information.

3. The method according to claim 1, wherein if the element associated with the shooting application is a flashing light, switching the operation status of the element associated with the shooting application according to the preset control information comprises:
switching the operation status of the flashing light into ON, OFF, or AUTO according to preset control information.

4. The method according to claim 1, wherein if the element associated with the shooting application is a front camera, switching the operation status of the element associated with the shooting application according to the preset control information comprises:
switching the operation status of the front camera into a photo shooting status or a video shooting status according to the preset control information.

5. The method according to claim 1, wherein if the element associated with the shooting application is a rear camera, switching the operation status of the element associated with the shooting application according to the preset control information comprises:
switching the operation status of the rear camera into a photo shooting status or a video shooting status according to the preset control information.

6. The method according to claim 1, wherein:
if the touch control region comprises one region,
the control information comprises: a correspondence between the touch control operation and the element, and a switching order corresponding to a plurality of operation status of the element; and
switching the operation status of the element associated with the shooting application according to the preset control information comprises:
acquiring the element corresponding to the touch control operation according to the touch control operation and the correspondence; and
switching among the plurality of operation status corresponding to the element under control according to the switching order corresponding to the element.

7. The method according to claim 1, wherein:
if the touch control region comprises a plurality of regions,
the control information comprises: a correspondence between the touch control operation in each touch control region and the element, and a switching order corresponding to a plurality of operation status of the element; and
switching the operation status of the element associated with the shooting application according to the preset control information comprises:
acquiring the element corresponding to the touch control region according to the touch control operation received in the touch control region and the correspondence; and
switching among the plurality of operation status corresponding to the element according to the switching order corresponding to the element.

8. The method according to claim 1, wherein the touch control operation comprises:
single-finger tapping, multi-finger tapping, double click, single-finger sliding, and/or multi-finger sliding.

9. The method according to claim 1, wherein the touch control region comprises: a left side region of the display screen, a right side region of the display screen, and/or a lower side region of the display screen.

10. A terminal apparatus with a shooting function, comprising:
a processor;
an element associated with the shooting application; and
a memory for storing instructions executable by the processor;
wherein the processor is configured to perform:
upon detecting an initialization of a function of the shooting application, monitoring, under the operating interface of the shooting application, whether a preset touch control operation is received on a preset touch control region on the display screen, the touch control region being preset according to a strategy for ease of a single hand operation; and
if it is determined that the touch control operation is received on the touch control region, switching operation status of the element associated with the shooting application according to preset control information.

11. The terminal apparatus according to claim 10, wherein if the element associated with the shooting application is a camera, switching the operation status of the element associated with the shooting application according to the preset control information comprises:
switching the operation status of the camera into a front camera shooting status or a rear camera shooting status according to the preset control information.

12. The terminal apparatus according to claim 10, wherein if the element associated with the shooting application is a flashing light, switching the operation status of the element associated with the shooting application according to the preset control information comprises:
switching the operation status of the flashing light into ON, OFF, or AUTO according to preset control information.

13. The terminal apparatus according to claim 10, wherein:
if the touch control region comprises one region,
the control information comprises: a correspondence between the touch control operation and the element, and a switching order corresponding to a plurality of operation status of the element; and
switching the operation status of the element associated with the shooting application according to the preset control information comprises:
acquiring the element corresponding to the touch control operation according to the touch control operation and the correspondence; and
switching among the plurality of operation status corresponding to the element under control according to the switching order corresponding to the element.

14. The terminal apparatus according to claim 10, wherein:
if the touch control region comprises a plurality of regions,
the control information comprises: a correspondence between the touch control operation in each touch control region and the element, and a switching order corresponding to a plurality of operation status of the element; and
switching the operation status of the element associated with the shooting application according to the preset control information comprises:
acquiring the element corresponding to the touch control region according to the touch control operation received in the touch control region and the correspondence; and
switching among the plurality of operation status corresponding to the element according to the switching order corresponding to the element.

15. A non-transitory computer-readable storage medium having stored therein instructions that, when executed by a processor of terminal apparatus, causes the terminal apparatus to perform a method for adjusting a shooting function, the method comprising:
upon detecting an initialization of a function of the shooting application, monitoring, under the operating interface of the shooting application, whether a preset touch control operation is received on a preset touch control region on the display screen, the touch control region being preset according to a strategy for ease of a single hand operation; and
if it is determined that the touch control operation is received on the touch control region, switching operation status of an element associated with the shooting application according to preset control information.

16. The non-transitory computer-readable storage medium according to claim 15, wherein if the element associated with the shooting application is a camera, switching the operation status of the element associated with the shooting application according to the preset control information comprises:
switching the operation status of the camera into a front camera shooting status or a rear camera shooting status according to the preset control information.

17. The non-transitory computer-readable storage medium according to claim 15, wherein if the element associated with the shooting application is a flashing light, switching the operation status of the element associated with the shooting application according to the preset control information comprises:
switching the operation status of the flashing light into ON, OFF, or AUTO according to preset control information.

18. The non-transitory computer-readable storage medium according to claim 15, wherein:
if the touch control region comprises one region,
the control information comprises: a correspondence between the touch control operation and the element, and a switching order corresponding to a plurality of operation status of the element; and
switching the operation status of the element associated with the shooting application according to the preset control information comprises:
acquiring the element corresponding to the touch control operation according to the touch control operation and the correspondence; and
switching among the plurality of operation status corresponding to the element under control according to the switching order corresponding to the element.

19. The non-transitory computer-readable storage medium according to claim 15, wherein:
if the touch control region comprises a plurality of regions,
the control information comprises: a correspondence between the touch control operation in each touch control region and the element, and a switching order corresponding to a plurality of operation status of the element; and
switching the operation status of the element associated with the shooting application according to the preset control information comprises:
acquiring the element corresponding to the touch control region according to the touch control operation received in the touch control region and the correspondence; and
switching among the plurality of operation status corresponding to the element according to the switching order corresponding to the element.
